(19) United States
(12) Patent Application Publication
(10) Pub. No.: US 2008/0311327 A1
(43) Pub. Date: Dec. 18, 2008

(54) Plastics Material Tube

(75) Inventors: Erwin Pasbrig, Singen (DE); Otto Hummel, Singen (DE)

Correspondence Address: FISHER, CHRISTEN & SABOL, 1120 20TH STREET, NW, SOUTH TOWER, SUITE 750, WASHINGTON, DC, 20036, US

(73) Assignee: ALCAN TECHNOLOGY & MANAGEMENT LTD., Neuhausen am Rheinfall (CH)

(21) Appl. No.: 11/883,346

(22) PCT Filed: Jan. 26, 2006
(86) PCT No.: PCT/EP06/00665

§ 371 Date: Jul. 31, 2007

(30) Foreign Application Priority Data
Feb. 14, 2005 (DE) 10 2005 006 667.4

(51) Int. Cl. B32B 1/08

(52) U.S. Cl. 428/36.7; 428/36.6

(57) ABSTRACT

The invention relates to a plastic tube comprising a tube body consisting of a multi-layer film (5) that includes at least one gas- and water-tight barrier film (7). The barrier film (7) has a polyglycolic acid (PGA) layer (9), at least one side of which is connected to a thermoplastic plastic layer (13, 15) by means of a layer (11, 12) consisting of an adhesion promoter. The adhesion promoter (11, 12) comprises a metal compound and has a layer thickness of between 100 and 500 nm.

The invention relates to a plastics material tube according to the preamble of claim 1.

Tubes of this type are frequently used for storing pasty substances such as, for example, toothpaste, shaving cream, cosmetic ointments or else food. A tube of this type has a tube body, which consists of a single-layer or multi-layer sheet.

Tube bodies of known plastics material tubes consist, for example, of low density polyethylene. The disadvantage for these is a relatively high permeability to gases and water vapours, which impairs the storage quality of the filled product. Tube bodies made of multi-layer sheets are also known, which have a sandwich structure with a barrier layer arranged between the outer layer and the inner layer.

EP 0 925 915 A1 describes a multi-layer sheet of this type in which a polyglycolic acid (PGA) layer is the gastight and watertight barrier. An adhesive layer is applied on the two sides of the PGA layer, by way of which adhesive layer the PGA layer is adhesively connected, in each case, to a plastics material layer. The layer thickness of the adhesive layer is preferably, in this case, 3 μm to 0.5 mm. The adhesive layer is used, in this case, to meet the adhesion requirements between the PGA layer and the outer covering layers. Polymers are used as the adhesive layer, for example carboxylated polyolefin. The covering layers preferably consist of polyolefin and have layer thicknesses between 4 μm and 5 mm.

It is also known to produce multi-layer sheets of this type by extrusion or coextrusion methods.

Proceeding from the above-described prior art, the invention sets itself the object of providing a plastics material tube, the production of which is connected with lower consumption of material, while the adhesion capacity of individual layers of the multi-layer sheet forming the tube body is not lastingly influenced.

To achieve this object, a plastics material tube with a tube body which is made of a multi-layer sheet is proposed, the sheet of which has at least one gastight and watertight barrier film, the barrier film comprising at least one polyglycolic acid layer, which is adhesively connected at least on one side to a thermoplastic plastics material layer by way of a layer of an adhesion promoter, the adhesion promoter having a metal compound and the layer thickness of the adhesion promoter being 100 to 500 nm.

A saving in raw materials in the production of a plastics material tube of this type can be achieved by the use of a metal compound as the adhesion promoter and by a reduced layer thickness of the adhesion promoter in comparison to the prior art. The visual properties of the plastics material tube which is produced in this manner are only influenced minimally with regard to their transparency, while the adhesion between the PGA layer forming the barrier and the respective thermoplastic plastics material layer remains adequately high.

Preferred embodiments of the plastics material tube according to the invention are disclosed in the dependent claims 2 to 12.

The embodiments of the plastics material tube according to the invention are described in more detail below with the aid of drawings, in which:

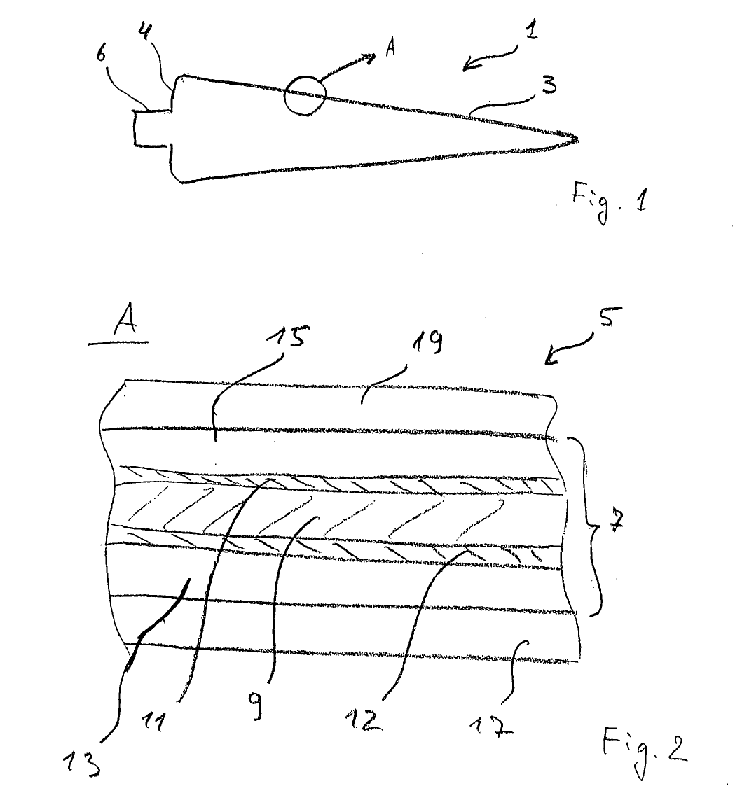

FIG. 1 shows a schematic cross sectional view of a plastics material tube according to the invention;

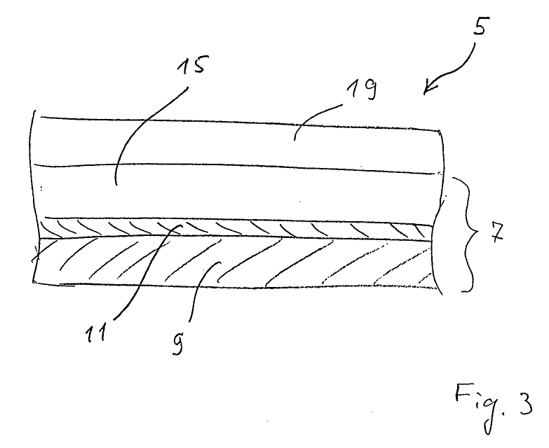

FIG. 2 shows a schematic cross sectional view of a multi-layer sheet forming a tube body;

FIG. 3 shows a different embodiment of a multi-layer sheet forming a tube body.

FIG. 1 shows a longitudinal sectional view of a plastics material tube 1 for storing and metering pasty substances. A plastics material tube 1 has a tube shoulder 4 with an outlet nozzle 6, a tube body 3 being provided in a gastight manner at the outer periphery of the tube shoulder 4. The tube body 3, together with the tube shoulder 4 and with the outlet nozzle 6, forms a gastight and watertight container. The composition of the tube body 3 is shown in FIG. 2 in a part section designated A in FIG. 1.

FIG. 2 shows a multi-layer structure of the tube body 3 in the form of a tube laminate 5 designed as a multi-layer sheet. The tube laminate 5 consists of a multi-layer barrier film 7, which is adhesively connected, on the inside of the tube laminate 5 forming the tube body 3, to an inner layer 17 made of a linear low density polyethylene (LLDPE) and, on the outside of the tube laminate 5, to an outer layer 19 made of polyethylene. The layer thicknesses of the inner layer 17 and the outer layer 19 are 60 μm and 90 μm.

The barrier film 7 comprises a PGA layer 9, on the two sides of which a layer of an adhesion promoter 11 and 12 is provided in each case, by way of which the PGA layer 9 is adhesively connected in each case to a covering layer 13 and 15 formed from a thermoplastic plastics material.

The thickness of the PGA layer 9 is 15 μm and this forms a necessary gas and water vapour barrier and gives the tube laminate 5 a necessary restoring force.

To improve the binding properties of the PGA layer 9 to the covering layers 13, 15, a layer of adhesion promoter 11, 12 is provided between them in each case. The adhesion promoter layer 11, 12 is formed by a metal layer made of chromium, the thickness of which is 300 mm. The two layers of the adhesion promoter 11, 12 are applied by painting with a volatile solvent to the PGA layer 9. The adhesion promoter 11, 12 can also be applied to the PGA layer 9 by coextrusion lamination or a thin layer process, such as vapour depositing or sputtering on a metal layer. Further metals may also be used as the adhesion promoter 11, 12, such as aluminium, titanium, nickel, molybdenum, iron and alloys of these metals or their oxides. The adhesion promoter 11, 12 may also have polymeric materials in its composition. However, a minimum content of 50% by weight, preferably over 70% by weight, of the metal compound in the adhesion promoter 11, 12 is necessary to ensure the adhesion properties between the PGA layer 9 and the covering layer 13 and 15.

The covering layers 13, 15 forming the outer face of the barrier film 7 consist of polyethylene with a layer thickness of 20 μm. This layer thickness, depending on the purpose of use, may be varied between 5 and 100 μm. In a further alternative embodiment, the covering layer 13, 15 may consist of a different polyolefin, such as polypropylene or of polyesters, polystyrenes, polyvinyl chloride, polycarbonates, polyamides or polyurethanes.

The barrier film 7 is preferably produced in the form of a coextruded sheet or a cast sheet. Thus, during the coextrusion of the PGA layer 9, the two layers of the adhesion promoter 11, 12 and the covering layers 13, 15 are joined together by means of melt extrudate by coextrusion technology. In the cast process, the barrier film 7 is simultaneously introduced, with the inner layer 17 and with the outer layer 19, in an extrusion operation. The barrier film 7 which is produced in this manner is therefore easy to handle in the following production process of the plastics material tube 1 and can be produced ahead.

The inner layer 17 of the tube laminate 5, after the plastics material tube 1 has been filled, comes into contact with a filling. Consequently, the composition of the inner layer 17 must have good resistance with respect to a large number of filled products. Furthermore, the inner layer 17 must have a high sealed seam strength with respect to itself and to the tube shoulder 4. Moreover, for the storage of food, toothpaste or cosmetic products, the corresponding authorisation prerequisites for the raw materials have to be taken into account. Apart from the already mentioned LLDPE (linear low density polyethylene), LMDPE (linear medium density polyethylene), LDPE (low density polyethylene) or HDPE (high density polyethylene) correspond to all these requirements.

The outer layer 19 of the tube laminate 5 consists of a coloured or a transparent sheet, the free surface of the outer layer 19 being smooth and easy to print. The face of the outer layer 19 facing the filled product has to have good welding behaviour relative to the covering layer 15 so a reliable weld is ensured between the two layers. Apart from the polyethylene already mentioned, the further polymers mentioned with respect to the covering layer 13, 15, from case to case, also correspond to these requirements.

Both the inner layer 17 and the outer layer 19 may be formed as a mono-layer or multi-layer coextrusion sheet.

FIG. 3 shows another embodiment of the plastics material tube according to the invention, the tube laminate 5 of which has a strong asymmetry in its structure. The embodiment shown here differs from the structure of the tube laminate 5 shown in FIG. 2 in that the PGA layer 9 is only in contact on one side with the covering layer 15 by way of the adhesion promoter. In this embodiment, the PGA layer 9 forms the inside of the tube laminate 5. The barrier layer 7 thus contacts the filled product of the plastics material tube 1 directly with the PGA layer 9. The required rigidity of the tube laminate 5 is obtained in this case by increasing the thickness of the covering layer 15 to 300 μm.

The tube laminate 5 may also be produced in this embodiment by means of coextrusion technology, while the PGA layer 9 is obtained directly from the liquid melt.

1: A plastics material tube (1), with a tube body (3) which is made of a multi-layer sheet (5), which has at least one gastight and watertight barrier film (7), the barrier film (7) comprising at least one polyglycolic acid (PGA) layer (9), which is adhesively connected at least on one side to at least one thermoplastic plastics material layer (13, 15) by way of a layer of an adhesion promoter (11, 12), wherein
the adhesion promoter (11, 12) has a metal compound, and
the layer thickness of the adhesion promoter (11, 12) is 100 to 500 nm.

2: The plastics material tube according to claim 1, wherein a layer of the adhesion promoter (11, 12) is applied to the two sides of the PGA layer (9), by way of which layer of adhesion promoter the PGA layer (9) is adhesively connected in each case to a thermoplastic plastics material layer (13, 15).

3: The plastics material tube according to claim 2, wherein the metal compound has at least one member of the group consisting of Cr, Al, Ti, Ni, Mo, Fe, alloys of these metals, and oxides thereof.

4: The plastics material tube according to claim 3, wherein the adhesion promoter (11, 12) is applied by vapor depositing or by ion bombardment onto the PGA layer (9).

5: The plastics material tube according to claim 3, wherein the adhesion promoter (11,12) is applied with a volatile solvent to the PGA layer (9).

6: The plastics material tube according to claim 5, wherein the thermoplastic plastics material layer (13, 15) is a member of the group consisting of polyolefin, polyester, polystyrene, polyvinyl chloride, polycarbonate, polyamide and polyurethane.

7: The plastics material tube according to claim 6, wherein the thickness of the thermoplastic plastics material layer (13, 15) is 5 to 100 μm.

8: The plastics material tube according to claim 7, wherein the thickness of the PGA layer (9) is 3 to 30 μm.

9: The plastics material tube according to claim 8, wherein the barrier film (7) is produced in the form of a coextruded sheet or cast sheet.

10: The plastics material tube according to claim 9, wherein the barrier film (7), on the inside of the multi-layer sheet (5) forming the tube body (3), is adhesively connected to an inner layer (17) made of an a-olefin copolymer.

11: The plastics material tube according to claim 10, wherein the barrier film (7), on the outside of the multi-layer sheet (5) forming the tube body (3), is adhesively connected to an outer layer (19) made of polyolefin.

12: The plastics material tube according to claim 9, wherein the multi-layer sheet (5) is produced by means of coextrusion.

13: The plastics material tube according to claim 1, wherein the metal compound has at least one member of the group consisting of Cr, Al, Ti, Ni, Mo, Fe, alloys of these metals, and oxides thereof.

14: The plastics material tube according to claim 13, wherein the adhesion promoter (11, 12) is applied by vapor depositing or by ion bombardment onto the PGA layer (9).

15: The plastics material tube according to claim 13, wherein the adhesion promoter (11, 12) is applied with a volatile solvent to the PGA layer (9).

16: The plastics material tube according to claim 1, wherein the thermoplastic plastics material layer (13, 15) is a member of the group consisting of polyolefin, polyester, polystyrene, polyvinyl chloride, polycarbonate, polyamide and polyurethane

17: The plastics material tube according to claim 1, wherein the thickness of the thermoplastic plastics material layer (13, 15) is 5 to 100 μm.

18: The plastics material tube according to claim 1, wherein the thickness of the PGA layer (9) is 3 to 30 μm.

19: The plastics material tube according to claim 1, wherein the barrier film (7) is produced in the form of a coextruded sheet or cast sheet.

20: The plastics material tube according to claim 1, wherein the barrier film (7), on the inside of the multi-layer sheet (5) forming the tube body (3), is adhesively connected to an inner layer (17) made of an a-olefin copolymer.

21: The plastics material tube according claim 1, wherein the barrier film (7), on the outside of the multi-layer sheet (5) forming the tube body (3), is adhesively connected to an outer layer (19) made of polyolefin.

22: The plastics material tube according to claim 19, wherein the multi-layer sheet (5) is produced by means of coextrusion.

23: The plastics material tube according to claim 1, wherein the barrier film (7), on the inside of the multi-layer sheet (5) forming the tube body (3), is adhesively connected to an inner layer (17) made of an a-olefin copolymer selected from the group consisting of a linear low density polyethylene (LLDPE), LMDPE (linear medium density polyethylene), LDPE (low density polyethylene) and HDPE (high density polyethylene).

24: The plastics material tube according to claim 1, wherein the barrier film (7), on the outside of the multi-layer sheet (5) forming the tube body (3), is adhesively connected to an outside layer (19) made of a polyethylene (PE) or a polypropylene.

25: The plastics material tube according to claim 9, wherein the barrier film (7), on the inside of the multi-layer sheet (5) forming the tube body (3), is adhesively connected to an inner layer (17) made of an a-olefin copolymer selected from the group consisting of a linear low density polyethylene (LLDPE), LMDPE (linear medium density polyethylene), LDPE (low density polyethylene) and HDPE (high density polyethylene).

26: The plastics material tube according to claim 9, wherein the barrier film (7), on the outside of the multi-layer sheet (5) forming the tube body (3), is adhesively connected to an outer layer (19) made of a polyethylene (PE) or a polypropylene.
